(19) United States
(12) Patent Application Publication
(10) Pub. No.: US 2025/0087683 A1
(43) Pub. Date: Mar. 13, 2025

(54) CATHODE COMPOSITE MATERIAL AND LITHIUM SECONDARY BATTERY

(71) Applicant: TOYOTA JIDOSHA KABUSHIKI KAISHA, Toyota-shi (JP)

(72) Inventor: Masataka TOMITA, Nisshin-shi (JP)

(73) Assignee: TOYOTA JIDOSHA KABUSHIKI KAISHA, Toyota-shi (JP)

(21) Appl. No.: 18/731,718

(22) Filed: Jun. 3, 2024

(30) Foreign Application Priority Data
Sep. 11, 2023 (JP) 2023-146793

(51) Int. Cl. H01M 4/525; H01M 4/02; H01M 4/131; H01M 4/62; H01M 10/052

(52) U.S. Cl. CPC H01M 4/525; H01M 4/131; H01M 4/623; H01M 4/625; H01M 10/052; H01M 2004/028

(57) ABSTRACT

The cathode composite material of the present disclosure contains a cathode active material composed of a lithium transition metal oxide having a layered crystalline structure, a binder, and a conductivity aid. The lithium transition metal oxide includes nickel, cobalt, and manganese. The binder includes polyvinylidene fluoride. The conductivity aid includes carbon nanotubes. The amount of lithium hydroxide contained in the cathode active material is 0.15% by mass or more and 0.35% by mass or less with respect to the total amount of the cathode active material.

### CROSS-REFERENCE TO RELATED APPLICATION

This application claims priority to Japanese Patent Application No. 2023-146793 filed on Sep. 11, 2023, incorporated herein by reference in its entirety.

### BACKGROUND

### 1. Technical Field

The present disclosure relates to a cathode composite material and a lithium secondary battery.

### 2. Description of Related Art

A lithium secondary battery using a non-aqueous electrolyte solution (hereinafter, also referred to as “lithium secondary battery”) is used in information communication technology (e.g., personal computers, smartphones, and so forth), in-vehicle equipment, power storage, and the like.

Japanese Unexamined Patent Application Publication No. 2019-164960 (JP 2019-164960 A) discloses a production method of a cathode for a non-aqueous electrolyte lithium secondary battery. This production method includes a step of preparing a cathode composite material paste using a cathode active material, polyvinylidene fluoride, acetic anhydride, and a solvent, a step of coating the cathode composite material paste upon a cathode current collector, and a step of drying the cathode composite material paste that has been coated. The mass ratio of LiOH contained in the cathode active material to the polyvinylidene fluoride is no less than 0.040 and no more than 0.075. The amount of the acetic anhydride as to the amount of the total solid component in preparing the cathode composite material paste is no less than 0.01% by mass and no more than 0.2% by mass.

### SUMMARY

Migration may occur when forming a cathode composite material layer that is relatively thick (cathode composite material layer having a grammage of no less than 38 mg/cm²). “Migration” refers to a phenomenon in which a binder (e.g., polyvinylidene fluoride or the like) and a conductivity aid float up to the surface of the coated material when the coated material of the cathode composite material paste is drying. When migration occurs, ion diffusivity of the cathode composite material layer that is yielded may deteriorate. As a result, discharge rate characteristics of the lithium secondary battery may deteriorate.

The present disclosure has been made in view of the above circumstances. An issue that an embodiment of the present disclosure has been made to solve, is to provide a cathode composite material and a lithium secondary battery that are capable of suppressing deterioration in discharge rate characteristics of a lithium secondary battery having a cathode composite material layer that is relatively thick.

Means for solving the above issue include the following aspects.

1. A cathode composite material contains
a cathode active material made of a lithium transition metal oxide with a layered crystalline structure, a binder, and a conductivity aid.
   The lithium transition metal oxide contains nickel, cobalt, and manganese,
the binder contains polyvinylidene fluoride,
the conductivity aid contains carbon nanotubes, and
an amount of lithium hydroxide contained in the cathode active material, as to a total amount of the cathode active material, is no less than 0.15% by weight and no more than 0.35% by weight.

2. A lithium secondary battery includes
a cathode, an anode, a separator disposed between the cathode and the anode, and a non-aqueous electrolyte solution.
   The cathode includes a cathode composite material layer that contains the cathode composite material according to the above 1.

3. In the lithium secondary battery according to the above 2, grammage of the cathode composite material layer is 35 mg/cm² to 46 mg/cm².

4. In the lithium secondary battery according to the above 3, the grammage of the cathode composite material layer is 35 mg/cm² to 40 mg/cm².

According to the present disclosure, there is provided a cathode composite material and a lithium secondary battery that are capable of suppressing deterioration in discharge rate characteristics of a lithium secondary battery having a cathode composite material layer that is relatively thick.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph of the zeta-potential difference ΔV with respect to LiOH content contained in the cathode active materials of Reference Example 1 to Reference Example 14;

FIG. 2 is a graph of 1C discharging rate with respect to the amounts of lithium hydroxide contained in the cathode active materials of Examples 1 to 9 and Comparative Examples 1 to 4; and

FIG. 3 is a graph of 1C discharging rate of the coating film of the cathode composite material paste with respect to the dry temperature.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B. In the numerical ranges described in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, a combination of two or more preferred embodiments is a more preferred embodiment. In the present disclosure, the amount of each component means the total amount of a plurality of substances unless otherwise specified, when a plurality of substances corresponding to each component are present. In the present disclosure, the term “step” is included in the term as long as the intended purpose of the step is achieved, even if it is not clearly distinguishable from other steps as well as independent steps.

### (1) Cathode Composite Material

The cathode composite material of the present disclosure contains a cathode active material composed of a lithium transition metal oxide having a layered crystalline structure, a binder, and a conductivity aid. The lithium transition metal oxide includes nickel (Ni), cobalt (Co), and manganese (Mn). The binder includes polyvinylidene fluoride (hereinafter, also referred to as “PVDF”). The conductivity aid includes carbon nanotubes (hereinafter, also referred to as “CNT”). The amount of lithium hydroxide contained in the cathode active material (hereinafter, simply referred to as “LiOH amount”) is 0.15% by mass or more and 0.35% by mass or less with respect to the total amount of the cathode active material.

In the present disclosure, the “cathode composite material” indicates the solid content of the cathode composite material layer included in the cathode of the lithium secondary battery. The lithium secondary battery may be a battery including a solid electrolyte or a battery including a non-aqueous electrolyte solution.

“lithium transition metal oxide” refers to a compound that can reversibly occlude and release lithium ions and that is included in LiOH. The lithium transition metal oxide may be represented by LiMO₂. M includes Ni, Co, and Mn, and may further include at least one selected from the group consisting of V, Cr, Fe, Cu, Zr, Nb, Mo, Ru, Pd, Ag, Hf, Ta, W, Ir, Pt, Au, and Pb.
The “layered crystalline structure of a lithium transition metal oxide” indicates a crystal structure in which a lithium layer and a transition metal layer including nickel, cobalt, and manganese are alternately arranged.
The “cathode active material” refers to a powder containing particles of a lithium transition metal oxide (hereinafter, also referred to as “particles of a cathode active material”) as a main component. The “main component” indicates that the proportion of the particles of the lithium transition metal oxide is 50% by mass or more with respect to the total amount of the cathode active material. The proportion of the particles of the lithium transition metal oxide may be 100% by mass with respect to the total amount of the cathode active material.

Since the cathode composite material of the present disclosure has the above-described configuration, it is possible to suppress a decrease in the discharge-rate property of a lithium secondary battery having a relatively thick cathode composite material layer (for example, a cathode composite material layer having a grammage of 38 mg/cm² or more).

This effect is presumed to be due to, but not limited to, the following reasons.
In the present disclosure, LiOH content is greater than or equal to 0.15% by mass and not more than 0.35% by mass. Accordingly, PVDF is easily adhered to the surface of the particles of the cathode active material when a relatively thick coating material of the cathode composite material paste containing the cathode composite material is dried. CNT has a higher affinity for PVDF. CNT easily adheres to PVDF attached to the grains of the cathode active material. Therefore, migration is unlikely to occur. As a result, it is presumed that the cathode composite material of the present disclosure can suppress a decrease in discharge rate characteristics of a lithium secondary battery having a relatively thick cathode composite material layer.

### (1.1) Cathode Active Material

The cathode active material is composed of a lithium transition metal oxide. The lithium transition metal oxide includes nickel, cobalt, and manganese, and may be represented by the following formula (I):

LiNiₓCo_{y}Mn_{z}O₂ Expression(I):

In the formula (I), a relationship of 0.5≤x<1, 0<y, 0<z, and x+y+z=1 is satisfied. x may be 0.60 or more, may be 0.80 or more, or may be 0.90 or more.
The cathode active material may be composed of one type of lithium transition metal oxide, or may be composed of at least two types of lithium transition metal oxides.

LiOH content of the cathode active material is from 0.15% by mass to 0.35% by mass with respect to the total amount of the cathode active material. LiOH content of the cathode active material may be, with respect to the total amount of the cathode active material, from 0.19% by mass to 0.35% by mass, from 0.23% by mass to 0.35% by mass, and from 0.31% by mass to 0.35% by mass. The method for measuring LiOH quantity is the same as the method described in the embodiment.

The average particle diameter of the cathode active material may be 1 μm to 20 μm, or 5 μm to 15 μm. The “average particle diameter” indicates a particle diameter (median diameter) corresponding to a cumulative frequency of 50% by volume from a fine particle side having a small particle diameter in a volume-based particle size distribution based on laser diffraction and light scattering.

The content of the cathode active material may be more than 50% by mass and may be 80% by mass or more and 97% by mass or less with respect to the total amount of the cathode composite material.

### (1.2) Binder

The binder includes PVDF and may include other binders that differ from PVDF. The binder may be a PVDF. Other binders include, for example, carboxymethyl cellulose, a rubber-based binder, a fluoride-based binder, a polyolefin-based thermoplastic resin, an imide resin, an amide resin, an acrylic resin, a methacrylic resin, and the like. Examples of the rubber-based binder include butadiene rubber and hydrogenated butadiene rubber. Examples of the fluoride-based binder include polyvinylidene fluoride-polyhexafluoropropylene copolymer (PVDF-HFP) and polytetrafluoroethylene (PTFE). Examples of the polyolefin-based thermoplastic resin include polyethylene, polypropylene, and polystyrene. Examples of the imide resin include polyimide and polyamide-imide. The amide resin is, for example, polyamide or the like. Examples of the acrylic resin include polymethyl acrylate and polyethyl acrylate. Examples of the methacrylic resin include polymethyl methacrylate and polyethyl methacrylate.

The content of the binder may be 0.1% by mass to 10% by mass with respect to the total amount of the cathode composite material.

### (1.3) Conductivity Aid

The conductivity aid may comprise CNT and may further comprise a carbonaceous material. The conductivity aid may be a CNT. CNT has a shape in which the graphene sheet is rounded into a single-layer or multi-layer cylindrical shape. CNT includes at least one of a single-walled carbon nanotube and a multi-walled carbon nanotube (hereinafter, also referred to as “MWCNT”). Examples of the carbon material include carbon black (for example, acetylene black, furnace black, Ketjen black, and the like), coke, and graphite.

The content of the conductivity aid may be 0.1% by mass to 10% by mass with respect to the total amount of the cathode composite material.

### (2) Lithium Secondary Battery

The lithium secondary battery of the present disclosure includes a cathode, an anode, a separator disposed between the cathode and the anode, and a non-aqueous electrolyte solution. The cathode includes a cathode composite material layer including the cathode composite material of the present disclosure. Accordingly, in the lithium secondary battery of the present disclosure, even if the thickness of the cathode composite material layer is relatively large, it is possible to suppress a decrease in discharge rate characteristics.

The structure of the lithium secondary battery is not particularly limited, and examples thereof include a wound type and a laminated type. The winding type is formed by winding a straight electrode body in which an anode, a separator, and a cathode are laminated in this order. In the laminated type, an anode, a separator, and a single-wafer-shaped electrode body in which cathodes are laminated in this order are laminated.

### (2.1) Cathode

The cathode may include a cathode composite material layer, and may further include a cathode current collector (e.g., aluminum foil). The cathode composite material layer is laminated on at least one main surface of the cathode current collector. The cathode composite material layer comprises the cathode composite material of the present disclosure.

The grammage of the cathode composite material layers is preferably from 35 mg/cm² to 46 mg/cm². Thus, deterioration of the discharge rate characteristics of the lithium secondary battery is further suppressed.

The grammage of the cathode composite material layers is more preferably from 35 mg/cm² to 40 mg/cm². Thus, the deterioration of the discharge rate characteristics of the lithium secondary battery is further suppressed.

### (2.2) Anode

The anode includes an anode current collector, and may or may not further include an anode composite material layer.

When the anode does not have the anode composite material layer, the anode current collector includes a main surface on which lithium metal is deposited during charging. Specifically, lithium ions contained in the non-aqueous electrolyte solution receive electrons on the anode current collector by charging, and lithium metal is deposited. The deposited lithium metal dissolves as lithium ions in the non-aqueous electrolyte solution by discharge. The lithium ions contained in the non-aqueous electrolyte solution may be at least one of ions derived from a lithium salt to be described later and ions supplied from the cathode active material by charging.

When the anode has the anode composite material layer, the anode composite material layer is laminated on at least one main surface of the anode current collector (for example, copper foil or the like). The anode composite material layer includes an anode layer active material (e.g., carbon (e.g., natural graphite, artificial graphite), a compound capable of alloying with lithium (e.g., silicon, tin, etc.)) capable of absorbing and desorbing charge carriers. The anode composite material layer may further contain, if necessary, a conductivity aid for increasing the electron conductivity, a binder, an electrolyte supporting salt (lithium salt) for increasing the ion conductivity, a polymer electrolyte, and an additive. The conductivity aid is, for example, acetylene black or the like. The binder is, for example, polyvinylidene fluoride. Examples of the additive include trifluoropropylene carbonate and the like. The anode may have a known configuration.

### (2.3) Separator

The separator maintains a gap between the cathode and the anode to prevent the occurrence of a contact short circuit, and allows lithium ions to pass through the separator. Examples of the separator include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methyl cellulose. The separator may have a known configuration.

### (2.4) Non-Aqueous Electrolyte Solution

The non-aqueous electrolyte solution may include a non-aqueous solvent and a lithium salt. Examples of the lithium salt include, LiClO₄, LiAsF₆, LiPF₆, LiBF₄, LiCF₃SO₃, LiN(FSO₂)₂, LiN(CF₃SO₂)₂. Examples of the non-aqueous solvent include cyclic carbonates, chain carbonates, cyclic esters, chain esters, and ethers. Examples of the cyclic carbonates include ethylene carbonate and the like. Examples of the chain carbonates include dimethyl carbonate and ethyl methyl carbonate. Examples of the cyclic esters include γ-butyl lactone and γ-valerolactone. Examples of the chain esters include methyl formate and methyl acetate. Examples of the ethers include dimethoxyethane and ethoxymethoxyethane. The non-aqueous electrolyte solution may contain an additive (for example, vinylene carbonate, lithium bis(oxalato)borate, or the like).

### (2.5) Case

A lithium secondary battery usually has a case. The case contains a cathode, an anode, a separator, and a non-aqueous electrolyte solution. The case is not particularly limited, and examples thereof include a laminate film (for example, an aluminum sheet, etc.), a battery can (for example, a cylindrical shape, a square shape, a coin shape, etc.), and the like.

Hereinafter, the present disclosure will be described in more detail with reference to Examples, but the embodiment of the present disclosure is not limited to these Examples.

### [1] Calculation of LiOH Quantity of Cathode Active Material

LiOH content of the cathode active material was calculated using a neutralization titration method. Specifically, a pure water 100 mL was added to the cathode active material 10 g and stirred for 1 minute to obtain a dispersion. The dispersion was subjected to suction filtration to obtain a filtrate. The filtrate was titrated with 25 μL of hydrochloric acid every 30 seconds. The amounts of OH⁻ in lithium hydroxide (LiOH) were determined by neutralization titration. The amount of OH⁻ was used to calculate the amount of Li⁺ (the amount of lithium derived from LiOH) using a molar ratio of OH⁻ to lithium ions (Li⁺) (molar/Li⁺ of OH⁻) of 1/1. The amount of OH⁻ and the amount of Li⁺ were used to calculate the weight of LiOH. The ratio of the mass of LiOH to the total amount of the cathode active material (i.e., “LiOH amount”) was calculated.

When the cathode active material was composed of one type (cathode active material A), LiOH content of the cathode active material A was defined as “LiOH content of the cathode active material”.

When the cathode active material was composed of two types (cathode active material A and cathode active material B), the calculated value of the following equation (1) was defined as the “LiOH amount of the cathode active material”. In the equation (1), the “blending ratio of the cathode active material A” indicates the ratio of the mass of the cathode active material A to the total amount of the cathode active material. The “blending ratio of the cathode active material B” indicates the ratio of the mass of the cathode active material B to the total amount of the cathode active material.

$$LiOH amount of cathode active material = LiOH amount of cathode active material A \times mixing ratio of cathode active material A \times LiOH amount of cathode active material B \times mixing ratio of cathode active material B \qquad Equation ( 1 )$$

### [2] Relation Between LiOH Content of Cathode Active Material and Zeta-Potential

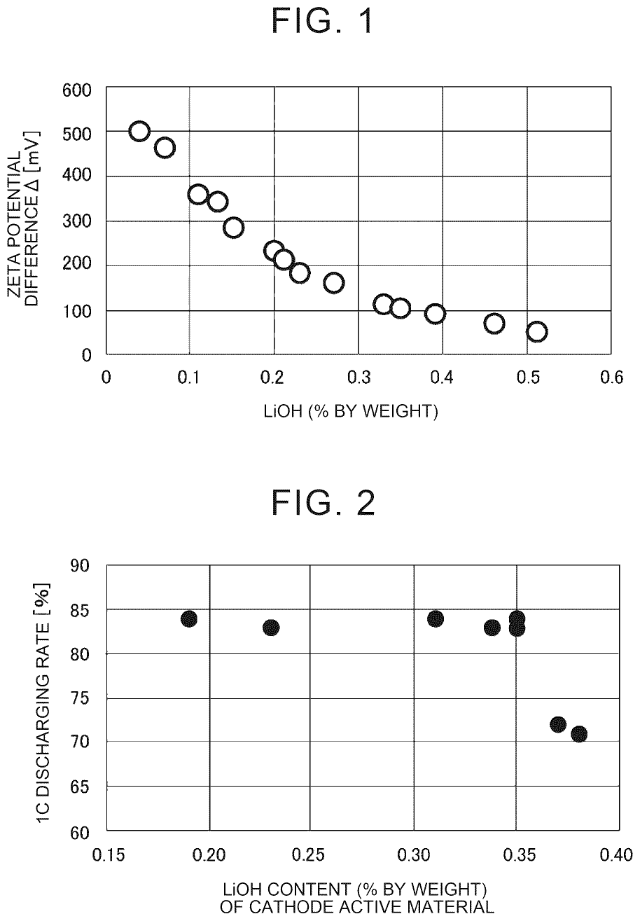

The cathode active materials shown in Table 1 were prepared. The cathode active material was mixed with N-methylpyrrolidone (NMP) (solvent of the cathode composite material paste) to obtain a first solution. The solid content NV (Non Volatile) of the cathode active material of the first solution was 75% by weight. A cathode active material, polyvinylidene fluoride (PVDF) (a binder of a cathode composite material paste), and N-methylpyrrolidone (NMP) (solvents of a cathode composite material paste) were mixed to obtain a second solution. The solid content NV (Non Volatile) of the cathode active material of the second solution was 75% by weight. The content of PVDF was 1.4% by mass with respect to 100% by mass of the sum of the cathode active material and PVDF. The zeta potential V1 of the first solution and the zeta potential V2 of the second solution were measured by ultrasonic damping method zeta potential measurement. The zeta-potential difference ΔV (mV) (absolute value) was calculated by the following equation (2). The calculation results are shown in FIG. 1 and Table 1.

$$zeta potential difference Δ V ( mV ) = \vert Zeta potential V 1 of the first solution - The zeta potential V 2 of the second solution \vert \qquad Equation ( 2 )$$

TABLE 1

| | cathode active material | | | | | Zeta |
|---|---|---|---|---|---|---|
| | Ni | Co | Mn | | | potential |
| | ratio | ratio | ratio | | LiOH | difference |
| | mol | mol | mol | | mass | ΔV |
| | % | % | % | Particle type | % | mV |
| Reference | 65 | 20 | 15 | Polycrystalline | 0.15 | 285 |
| Example 1 | | | | | | |
| Reference | 62 | 18 | 20 | Single particle | 0.04 | 506 |
| Example 2 | | | | | | |
| Reference | 80 | 10 | 10 | Polycrystalline | 0.23 | 182 |
| Example 3 | | | | | | |
| Reference | 60 | 20 | 20 | Polycrystalline | 0.13 | 345 |
| Example 4 | | | | | | |
| Reference | 77 | 13 | 10 | Polycrystalline | 0.20 | 234 |
| Example 5 | | | | | | |
| Reference | 84 | 9 | 7 | Polycrystalline | 0.27 | 160 |
| Example 6 | | | | | | |
| Reference | 71 | 18 | 11 | Polycrystalline | 0.21 | 210 |
| Example 7 | | | | | | |
| Reference | 70 | 19 | 11 | Single particle | 0.07 | 466 |
| Example 8 | | | | | | |
| Reference | 80 | 11 | 9 | Single particle | 0.11 | 362 |
| Example 9 | | | | | | |
| Reference | 89 | 8 | 3 | Polycrystalline | 0.33 | 116 |
| Example | | | | | | |
| 10 | | | | | | |
| Reference | 88 | 10 | 2 | Polycrystalline | 0.35 | 104 |
| Example | | | | | | |
| 11 | | | | | | |
| Reference | 90 | 7 | 3 | Polycrystalline | 0.39 | 91 |
| Example | | | | | | |
| 12 | | | | | | |
| Reference | 92 | 5 | 3 | Polycrystalline | 0.46 | 69 |
| Example | | | | | | |
| 13 | | | | | | |
| Reference | 93 | 4 | 3 | Polycrystalline | 0.51 | 53 |
| Example | | | | | | |
| 14 | | | | | | |

“Single particle” refers to a particle having the continuity of one crystal (i.e., a primary particle). “Polycrystalline” refers to a particle having no continuity of one crystal. Specifically, the term “polycrystalline” refers to secondary particles formed by sintering primary particles.

As shown in FIG. 1, it was found that the zeta-potential difference ΔV tended to be smaller as LiOH content of the cathode active material was higher. PVDF has fluorine atoms (F) with a high electronegativity. Therefore, when PVDF is adsorbed on the surface of the particles of the cathode active material, the repulsion between the particles of the cathode active material increases, and the zeta-potential of the second solution increases. When PVDF does not adhere to the cathode active material and is present alone, the repulsion between the grains of the cathode active material is small. Therefore, when LiOH content is large, PVDF hardly adheres to the active material, and thus the zeta-potential difference is small. As a result, migration is likely to occur. CNT is highly compatible with PVDF. Therefore, when PVDF is present on the surface of the particles of the cathode active material, CNT also easily adheres to the surface of the particles of the cathode active material.

As shown in Table 1, LiOH content of the cathode active material generally tends to be higher as Ni ratio of the active material is higher. Due to differences in the method of synthesizing the cathode active material, the cathode active material is generally divided into a powder (single particle type) having a high content of primary particles and a powder (polycrystalline type) having a high content of secondary particles. When the cathode active material is polycrystalline, LiOH content of the cathode active material tends to be higher. When Ni ratio of the cathode active material is high and the cathode active material is polycrystalline, LiOH content of the cathode active material tends to be high. If LiOH content of the cathode active material is too high (LiOH content is 0. More than 35%), PVDF is less likely to adhere to the cathode active material. As a result, migration is likely to occur. If too much LiOH is present on the surface of the particles of the cathode active material, PVDF is less likely to adhere to the surface of the particles of the cathode active material.

### Examples and Comparative Examples

### [3.1] Examples 1 to 7 and Comparative Examples 1 to 4

The cathode active material A, B shown in FIG. 2 was prepared. Each of the cathode active material A, B was composed of LiNiₓCo_{y}Mn_{z}O₂ (0.60≤x<1, 0<y, 0<z, x+y+z=1). As the cathode active material, a powder obtained by mixing the cathode active material A and the cathode active material B in the ratios shown in Table 2 was used.

A cathode composite material was prepared by mixing the cathode active material shown in Table 2, carbon nanotubes (MWCNT) as a conductivity aid, polyvinylidene fluoride (PVDF) as a binder, and N-methylpyrrolidone (NMP) as solvents. The mass-ratio of the cathode active material, MWCNT, and PVDF (cathode active material:MWCNT:PVDF) was 97.8:0.7:1.4. The cathode composite material paste was applied to an aluminum foil (thickness: 30 μm) with a doctor blade to form a coating. The coating was dried at 90° C. to 125° C. for 30 minutes. The coated material after drying was pressed so that the electrode density is 3.2 g/cc by a roll press. As a result, a cathode was obtained.

As a separator, a porous resin sheet having a three-layer structure (thickness: 16 μm) was prepared. The porous resin-sheet is formed by laminating a polypropylene (PP) layer, a polyethylene (PE) layer, and a PP layer in this order. As the anode, a Li metal was prepared.

The cathode, the separator, and the anode were stacked in this order and housed in a battery case having a liquid injection port. A coin cell (lithium secondary battery) was prepared by receiving a non-aqueous electrolyte solution from a liquid injection port of a battery case and sealing the liquid injection port. The non-aqueous electrolyte solution includes a mixed solvent, a LiPF₆ as a support salt, and vinylene carbonate (VC) as an additive. Mixed solvents include ethylene carbonate (EC), dimethyl carbonate (DMC), and ethyl methyl carbonate (EMC). The volume fraction (EC:DMC:EMC) of EC to DMC to EMC was 30:40:30. LiPF₆ was dissolved at the level of 1.1 mol/L. The content of VC was 1% by mass with respect to the total amount of the non-aqueous electrolyte solution.

### [3.2] Activation of the Lithium Secondary Battery

The initial charging current was a constant current-constant voltage system. Constant current (CC) charging is performed up to 4.25 V at 0.1 C current, constant voltage charging is performed until the time of constant voltage charging reaches 3 hours, discharging was performed until 2.5 V was reached at 0.1 C current, and the lithium secondary battery was activated.

### [3.3] 1C Sustain Rate of Lithium Secondary Battery

The charging and discharging were performed by a constant current method. The current rate was 0.1 C or 1.0 C. For details, in [2.2] above, the total discharge capacity (hereinafter, also referred to as “0.1 C-CC discharge capacity”) when discharged to from 4.25 V to 2.5 V at the current of 0.1 C was measured. Then, constant current (CC) charging is performed up to 4.25 V at the current of 1C, constant voltage charging is performed until the time of constant voltage charging reaches 3 hours, and discharging was performed until 2.5 V was reached at 1C current. The total discharge capacity at this time (hereinafter, also referred to as “1C-CC discharge capacity”) was measured. The “1C sustain charge rate (%)” was calculated by Equation (3) below. The calculation results are shown in FIG. 2 and Table 2. The acceptable 1C sustained charge rate is 73% or greater.

$$1 C discharge sustain charge rate ( \% ) = ( 0.1 C - CC discharge capacity / 1. C - CC discharge capacity ) \times 100. \qquad Equation ( 3 )$$

### [3.4] Results

TABLE 2

| | cathode active material | | | | | | |
|---|---|---|---|---|---|---|---|
| | | cathode active | | cathode active | | | |
| | | material A | | material B | | | 1 C |
| | Total | | Blending | | Blending | cathode | sustain |
| | LiOH | LiOH | ratio | LiOH | ratio | grammage | rate |
| | mass % | mass % | mass % | mass % | mass % | mg/cm² | % |
| Comparative | 0.38 | 0.38 | 100 | — | 0 | 38 | 71 |
| Example 1 | | | | | | | |
| Comparative | 0.38 | 0.38 | 100 | — | 0 | 43 | 62 |
| Example 2 | | | | | | | |
| Comparative | 0.38 | 0.38 | 100 | — | 0 | 50 | 38 |
| Example 3 | | | | | | | |
| Comparative | 0.37 | 0.39 | 90 | 0.19 | 10 | 38 | 72 |
| Example 4 | | | | | | | |
| Example 1 | 0.35 | 0.39 | 80 | 0.19 | 20 | 38 | 84 |
| Example 2 | 0.35 | 0.39 | 80 | 0.19 | 20 | 43 | 73 |
| Example 3 | 0.31 | 0.39 | 60 | 0.19 | 40 | 38 | 82 |
| Example 4 | 0.35 | 0.35 | 100 | — | 0 | 38 | 83 |
| Example 5 | 0.34 | 0.39 | 85 | 0.04 | 15 | 38 | 82 |
| Example 6 | 0.23 | 0.23 | 100 | — | 0 | 38 | 83 |
| Example 7 | 0.19 | 0.19 | 100 | — | 0 | 38 | 82 |

Even if LiOH volume is more than 0.35%, when the cathode grammage is thin (for example, when the cathode grammage is less than 38 mg/cm²), 1C sustain ratio tends to be higher. When the cathode grammage of the cathode is increased (when the thickness of the cathode is increased), ion diffusion in the cathode is rate-limiting. Therefore, the influence of migration becomes apparent, and the decrease in the discharge rate tends to increase.

### [3.4.1] Comparative Example 4 from Comparative Example 1

In Comparative Example 1 to Comparative Example 4, LiOH content of the cathode active material was not within 0.15% to 0.35%. Therefore, when the cathode grammage was 38 mg/cm² or more, 1C sustain ratio was not 73% or more. As a result, it was found that the cathode composite material of Comparative Example 1 to Comparative Example 4 is not a cathode composite material capable of suppressing a decrease in discharge rate characteristics of a lithium secondary battery having a relatively thick cathode composite layer.

### [3.4.2] Example 1 to Example 7

In Examples 1 to 7, LiOH content of the cathode active material was in the range of 0.15% to 0.35%. Therefore, when the cathode grammage was 38 mg/cm² or more, 1C discharging retention ratio was 73% or more. As a result, it was found that the cathode composite material of Examples 1 to 7 was a cathode composite material capable of suppressing a decrease in discharge rate characteristics of a lithium secondary battery having a relatively thick cathode composite layer.

### [3.5] Drying Temperature of the Coating

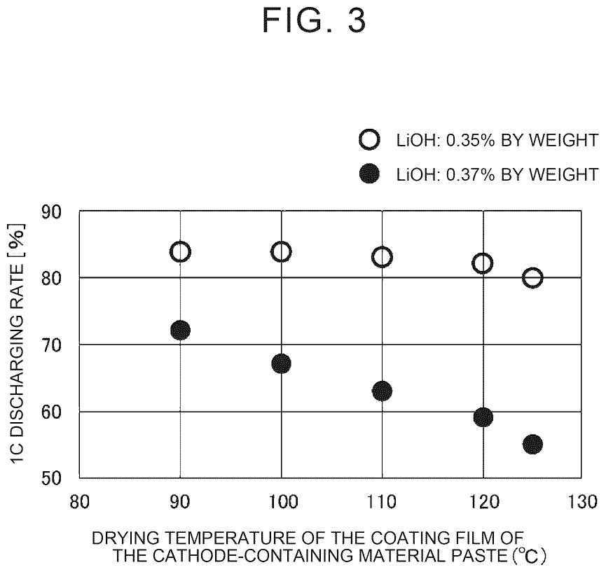

By adjusting LiOH content of the cathode active material within the range of 0.15% to 0.35%, it was found that migration is unlikely to occur. Therefore, it is possible to increase the drying temperature of the coating film at the time of producing the cathode composite material layer. For a composition in which LiOH content of the cathode active material is 0.35% and for the composition in which LiOH content of the cathode active material is 0.37%, a cathode was prepared by changing the dry-temperature of the coating film, and 1C discharge-retention ratio was calculated. FIG. 3 shows the results.

As shown in FIG. 3, when LiOH content of the cathode active material is 0.35%, 1C sustain rate remained high even at high dryness. When LiOH content of the cathode active material is 0.37%, the degree of migration was increased by increasing the dry temperature, and 1C sustain ratio was low.

What is claimed is:

1. A cathode composite material, containing a cathode active material made of a lithium transition metal oxide with a layered crystalline structure, a binder, and a conductivity aid, wherein:
the lithium transition metal oxide contains nickel, cobalt, and manganese;
the binder contains polyvinylidene fluoride;
the conductivity aid contains carbon nanotubes; and
an amount of lithium hydroxide contained in the cathode active material, as to a total amount of the cathode active material, is no less than 0.15% by weight and no more than 0.35% by weight.

2. A lithium secondary battery, comprising:
a cathode; an anode; a separator disposed between the cathode and the anode; and a non-aqueous electrolyte solution, wherein
the cathode includes a cathode composite material layer that contains the cathode composite material according to claim 1.

3. The lithium secondary battery according to claim 2, wherein grammage of the cathode composite material layer is 35 mg/cm² to 46 mg/cm².

4. The lithium secondary battery according to claim 3, wherein the grammage of the cathode composite material layer is 35 mg/cm² to 40 mg/cm².
